(19) United States
(12) Patent Application Publication
(10) Pub. No.: US 2020/0172388 A1
(43) Pub. Date: Jun. 4, 2020

(54) GAS PUMP IDENTIFICATION SYSTEM USING SENSORS AND METHOD OF CONTROLLING THE SAME

(71) Applicants: HYUNDAI MOTOR COMPANY, Seoul (KR); KIA MOTORS CORPORATION, Seoul (KR)

(72) Inventors: Ki Tag Yoo, Gwangmyeong-si (KR); Ji Hyun Shim, Seoul (KR)

(21) Appl. No.: 16/519,799

(22) Filed: Jul. 23, 2019

(30) Foreign Application Priority Data
Dec. 3, 2018 (KR) 10-2018-0153770

(51) Int. Cl. B67D 7/04; G06Q 20/32

(52) U.S. Cl. CPC B67D 7/04; G06Q 20/3278; B67D 2007/0444; B67D 2007/0403; G06Q 20/3276

(57) ABSTRACT

A gas pump identification system for identifying a gas pump through a non-contact type sensor provided in a vehicle and making payment may include acquiring, by a gas pump identification information acquirer disposed in a vehicle, identification information related to a gas pump from a gas pump identification information provider provided in a filling gun while the filling gun of the gas pump is inserted into a filling inlet of the vehicle, transmitting the acquired identification information to a terminal of the vehicle, and generating, by the terminal, order information based on the identification information and transmitting the order information to a payment server, wherein the gas pump identification information acquirer acquires the identification information from the gas pump identification information provider using a non-contact recognition method in a state in which the filling gun is inserted into the filling inlet.

The present application claims priority to Korean Patent Application No. 10-2018-0153770, filed on Dec. 3, 2018, the entire contents of which is incorporated herein for all purposes by this reference.

### BACKGROUND OF THE INVENTION

### Field of the Invention

The present invention relates to a gas pump identification system configured for identifying a gas pump through a non-contact type sensor provided in a vehicle and making payment, and a method of controlling the same.

### Description of Related Art

In a typical self-service gas station, when a driver directly selects the fuel amount and a payment means through a terminal provided in a gas pump and payment using a credit card succeeds, a filling gun is inserted into a filling inlet to start pumping gas. However, a payment method using such a terminal always requires a credit card. In many cases, the user interface of the terminal differs between gas stations, making it difficult to operate the terminal.

To solve such problems, various simple payment methods have been introduced. However, even in these methods, not only a gas station which a vehicle enters but also a gas pump to be used by a driver among a plurality of gas pumps in the gas station needs to be specified. The gas station which the vehicle enters may be specified without separate operation through recognition of the license number of the vehicle using a camera provided at the entrance of the gas station or based on global positioning system (GPS) coordinates of the vehicle. However, to identify a gas pump to be used, it is inconvenient for a driver to directly input the unique identification information related to the gas pump indicated on the outside of the gas pump. Of course, in some simple payment methods, a gas pump closest to a vehicle is specified based on the strength of a beacon signal through wireless communication. However, in the instant case, since communication interference or scattered reflection may occur due to entry of a large vehicle into a gas station, it is difficult to guarantee quality according to situations.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a gas pump identification system and a method of controlling the same that substantially obviate one or more problems due to limitations and disadvantages of the related art.

Various aspects of the present invention are directed to providing a gas pump identification system configured for identifying a gas pump in a gas station using a non-contact method, and a method of controlling the same.

Various aspects of the present invention are directed to providing a gas pump identification system configured for identifying a gas pump by inserting a filling gun into a filling inlet, and a method of controlling the same.

Additional advantages, objects, and features of the present invention will be set forth in part in the description which follows and in part will become apparent to those having ordinary skill in the art upon examination of the following or may be learned from practice of the present invention. The objectives and other advantages of the present invention may be realized and attained by the structure particularly pointed out in the written description and claims hereof as well as the appended drawings.

To achieve these objects and other advantages and in accordance with the purpose of the present invention, as embodied and broadly described herein, a method of controlling a gas pump identification system may include acquiring, by a gas pump identification information acquirer disposed in a vehicle, identification information related to a gas pump from a gas pump identification information provider provided in a filling gun while the filling gun of the gas pump is inserted into a filling inlet of the vehicle, transmitting the acquired identification information to a terminal of the vehicle, and generating, by the terminal, order information based on the identification information and transmitting the order information to a payment server. The gas pump identification information acquirer is configured for acquiring the identification information from the gas pump identification information provider using a non-contact recognition method in a state in which the filling gun is inserted into the filling inlet.

In another aspect of the present invention, a vehicle may include a gas pump identification information acquirer configured to acquire identification information related to a gas pump from a gas pump identification information provider provided in a filling gun while the filling gun of a gas pump is inserted into a filling inlet of the vehicle, and a terminal configured to generate order information based on the identification information and to transmit the order information to a payment server. The gas pump identification information acquirer is configured for acquiring the identification information from the gas pump identification information provider using a non-contact recognition method in a state in which the filling gun is inserted into the filling inlet.

In another aspect of the present invention, a gas pump identification system may include a vehicle including a gas pump identification information acquirer configured to acquire identification information related to a gas pump from a gas pump identification information provider provided in a filling gun while the filling gun of a gas pump is inserted into a filling inlet of the vehicle and a terminal configured to generate order information based on the acquired identification information, and a payment server configured to receive the generated order information from the terminal and to make payment based on the order information. The gas pump identification information acquirer is configured for acquiring the identification information from the gas pump identification information provider using a non-contact recognition method in a state in which the filling gun is inserted into the filling inlet.

In another aspect of the present invention, a vehicle may include a charger identification information acquirer configured to acquire identification information related to a charger from a charger identification information provider provided in a plug of the charger as the plug of the charger is inserted into a socket, and a terminal configured to generate order information based on the acquired identification information and to transmit the order information to a payment server. The charger identification information acquirer is configured for acquiring the identification information from the charger identification information provider using a non-contact recognition method in a state in which the plug is inserted into the socket.

For example, the charger identification information acquirer may approach the charger identification information provider within a predetermined distance in a state in which the plug is inserted into the socket.

For example, the charger identification information acquirer may be disposed near the socket.

For example, the charger identification information acquirer may include a near field communication (NFC) reader, and the charger identification information provider may include an NFC tag.

The non-contact recognition method may include at least one of an infrared (IR) communication method, a visible light communication method, a magnetic secure transmission (MST) method, an acoustic communication method, and a quick response (QR) code method.

For example, the order information may include at least one of charger identification information, payment means information, charging method (slow or fast) information or requested payment amount information or requested charge amount information, and the payment means information may include at least one of a credit card number, a membership number, discount means information, installment information, and loyalty card information.

In another aspect of the present invention, a charger identification system may include a vehicle including a charger identification information acquirer configured to acquire identification information related to a charger from a charger identification information provider provided in a plug of the charger as the plug of the charger is inserted into a socket and a terminal configured to generate order information based on the acquired identification information, and a payment server configured to receive the generated order information from the terminal and to make payment based on the order information, wherein the charger identification information acquirer is configured for acquiring the identification information from the charger identification information provider using a non-contact recognition method in a state in which the plug of the charger is inserted into the socket.

For example, the charger identification system may further include a local server configured to receive approval information related to the payment and the order information from the payment server and a charging station including the charger, and the local server may determine the charger based on the identification information included in the order information and transmit charger operation information corresponding to the order information to the charger.

It is to be understood that both the foregoing general description and the following detailed description of the present invention are exemplary and explanatory and are intended to provide further explanation of the present invention as claimed.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing an example of a sensor provided in each of a filling inlet and a filling gun applicable to embodiments of the present invention;

FIG. 2 is a view showing another example of a sensor provided in each of a filling inlet and a filling gun applicable to embodiments of the present invention;

FIG. 3 is a block diagram showing an example of the configuration of a gas pump identification system according to an exemplary embodiment of the present invention;

FIG. 4 is a flowchart illustrating an example of a gas pumping process from the viewpoint of a driver according to an exemplary embodiment of the present invention;

FIG. 5 is a flowchart illustrating a gas pumping process according to an exemplary embodiment of the present invention; and

FIG. 6 is a view showing an example of a charging process from the viewpoint of a client and a server according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, the exemplary embodiments of the present invention will be described in detail with reference to the accompanying drawings to be easily implemented by those skilled in the art. However, the present invention may be variously implemented and is not limited to the exemplary embodiments described herein. In the drawings, to clearly describe the present invention, portions which are not related to the description of the present invention will be omitted and similar portions are denoted by similar reference numerals throughout the specification.

In the entire specification, when a certain portion “includes” a certain component, this indicates that the other components are not excluded, but may be further included unless specially described. The same reference numbers will be used throughout the drawings to refer to the same or like parts.

In the exemplary embodiments of the present invention, a sensor for identifying a gas pump is provided in each of a vehicle and a filling gun, and the filling gun is inserted into the filling inlet such that the vehicle automatically acquires the identification information related to the gas pump.

To the present end, when the filling gun is inserted into or approaches the filling inlet, the vehicle acquires the unique identification information related to the gas pump held by the filling gun using a non-contact method. Accordingly, in the exemplary embodiments of the present invention, the filling gun includes a gas pump identification information provider for actively transmitting the unique identification information related to the gas pump to the filling inlet (regardless of the request of the filling inlet) or passively allowing the filling inlet to acquire the unique identification information related to the gas pump. Furthermore, the vehicle includes a gas pump identification information acquirer for actively reading the identification information related to the gas pump held by the filling gun or receiving the identification information related to the gas pump in a response to a request transmitted to the filling gun. At the instant time, the gas pump identification information acquirer acquires the identification information related to the gas pump in a state in which the filling gun is inserted into the filling inlet and thus may be provided adjacent to the filling inlet.

In the following description, for convenience, the gas pump identification information acquirer and the gas pump identification information provider may be collectively referred to as a sensor, regardless of whether active/passive operation is performed or whether detection is actually performed. For example, the gas pump identification information provider of the filling gun is referred to as a “filling gun sensor”, and the gas pump identification information acquirer on, near or adjacent to the filling inlet is referred to as a “filling inlet sensor”.

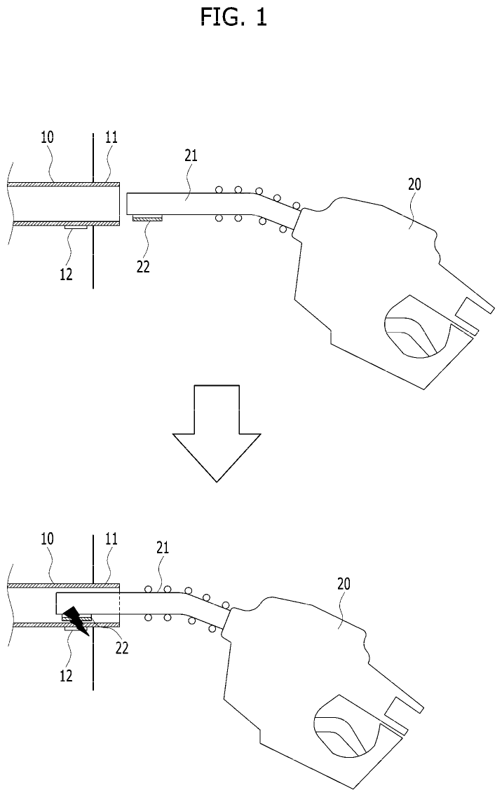

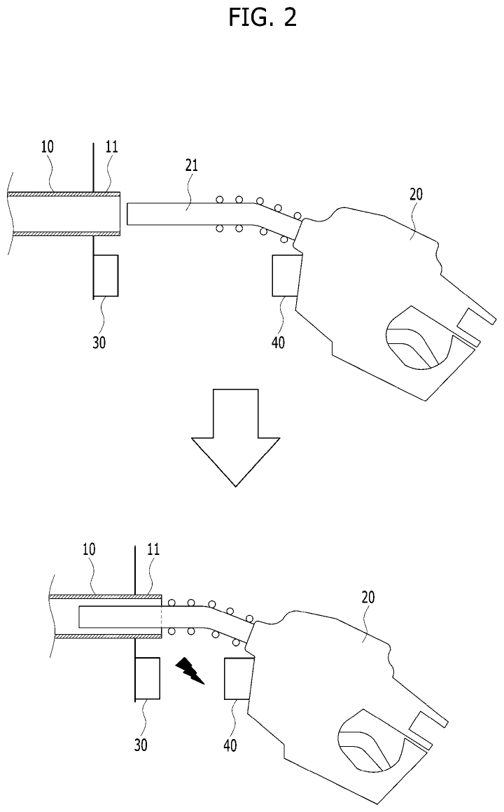

First, the configuration of the filling gun and the filling inlet, to which the exemplary embodiments of the present invention are applicable, will be described with reference to FIG. 1 and FIG. 2.

FIG. 1 is a view showing an example of a sensor provided in each of a filling inlet and a filling gun applicable to embodiments of the present invention, and FIG. 2 is a view showing another example of a sensor provided in each of a filling inlet and a filling gun applicable to embodiments of the present invention.

First, referring to the upper side of FIG. 1, one end portion of a gas pumping pipe 10 is connected to a fuel tank of a vehicle and the other end portion thereof is connected to a filling inlet 11 externally exposed of the vehicle. A filling gun 20 has a nozzle 21 having at least an external diameter less than the internal diameter of the filling inlet 11 and the nozzle 21 is inserted into the filling inlet 11 when pumping gas. At the instant time, a near field communication (NFC) tag 22 including gas pump identification information is mounted on the nozzle 21 of the filling gun 20 as a filling gun sensor and an NFC reader 12 is mounted inside the gas pumping pipe 10 as a filling inlet sensor. Here, the NFC tag 22 and the NFC reader 12 may be mounted to face each other when the nozzle 21 is inserted into the filling inlet 11. Accordingly, as shown at the lower side of FIG. 1, when the nozzle 21 is inserted into the filling inlet 11, the NFC reader 12 may read information recorded on the NFC tag 22 to acquire the gas pump identification information.

Next, referring to the upper side of FIG. 2, the filling gun 20 and the gas pumping pipe 10 are similar to those of FIG. 1, and infrared (IR) communication modules 30 and 40 are provided near the filling inlet 11 and near the nozzle 21 of the filling gun 20, respectively. The communication modules 30 and 40 may be close to each other within a minimum communication distance and disposed to face each other, when the nozzle 21 is inserted into the filling inlet 11. Accordingly, as shown in the lower side of FIG. 2, when the nozzle 21 is inserted into the filling inlet 11, the filling inlet side infrared communication module 30 and the filling gun side infrared communication module 40 become close to each other to face each other such that the filling gun side infrared communication module 40 transmits the gas pump identification information to the filling inlet side infrared communication module 30.

Of course, the non-contact recognition method and the positions and arrangement of the sensors shown in FIG. 1 and FIG. 2 are illustrative. The present invention is not limited thereto if the filling inlet sensor acquires the gas pump identification information from the filling gun sensor in a state in which the filling gun is inserted into the filling inlet. For example, the non-contact recognition method may include a visible light communication method, a magnetic secure transmission (MST) method, an acoustic communication method, and a quick response (QR) code method, in addition to the above-described IR method and the NFC method.

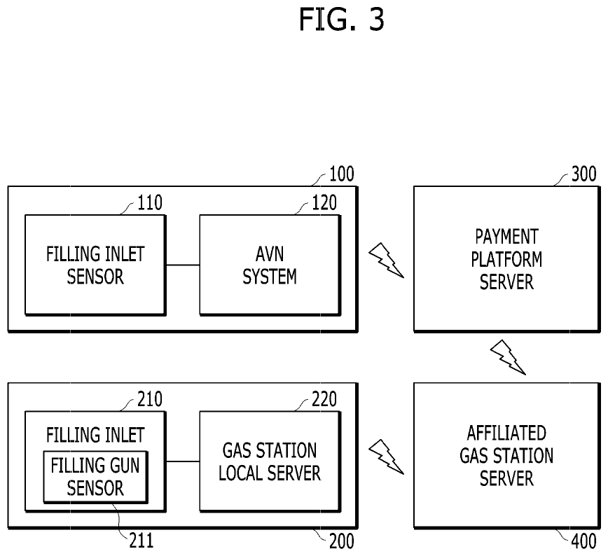

FIG. 3 is a block diagram showing an example of the configuration of a gas pump identification system according to an exemplary embodiment of the present invention.

Referring to FIG. 3, the gas pump identification system may include a vehicle 100, a gas station 200, a payment platform server 300 and an affiliated gas station server 400.

First, the vehicle 100 may include a filling inlet sensor 110 and an audio/video/navigation (AVN) system 120 (or an audio/video/navigation terminal (AVNT)).

The NFC reader 12 or the filling inlet side IR communication module 30 described with reference to FIG. 1 and FIG. 2 may correspond to the filling inlet sensor 110.

The AVN system 120 may transmit order information to the payment platform server through wireless communication based on the gas pump identification information acquired by the filling inlet sensor 110. At the instant time, the order information may include at least one of gas pump identification information, payment means information, fuel type information or requested payment amount information (and/or requested fuel amount information). Here, fuel type information may be included in the gas pump identification information. Furthermore, the payment means information may include at least one of a credit card number, a membership number, discount means information such as a coupon number or affiliation, installment information, and loyalty card information. Furthermore, the AVN system 120 may receive payment means information prestored in the server 300 in connection with account information by logging in to the payment platform server 300 to receive account information, use payment means information stored therein or directly receive at least a portion of payment means information from a user. Meanwhile, the AVN system 120 may output the payment means information and a final payment processing result through a display in a form of a predetermined on screen display (OSD).

The payment platform server 300 may pay for gas through an online payment system (e.g., a card purchase approval request through connection of a card company server) using the order information received from the AVN system 120 of the vehicle 100. Payment approval information for gas may be transmitted to the AVN system 120 and the affiliated gas station server 400. At the instant time, the payment platform server 300 may transmit the payment approval information to the affiliated gas station server 400 along with the order information.

The affiliated gas station server 400 may receive the order information and the payment approval information from the payment platform server 300 and transmit the order information and the payment approval information to a local server 220 of the gas station 200 corresponding to the gas pump identification information related to the order information among a plurality of gas stations managed thereby.

The gas station 200 may include one or more gas pumps 210 and the local server 220. Each gas pump 210 includes the filling gun sensor 211 configured for providing identification information thereof to the filling inlet sensor 110. For example, the filling gun sensor 211 may be implemented in a form of the NFC tag 22 or the filling gun side IR communication module 40 described with reference to FIG. 1 and FIG. 2 without being limited thereto and may be implemented to correspond to the filling inlet sensor 110.

The local server 220 may check the order information and the approval information received from the affiliated gas station server 400 and control the gas pump 210 (e.g., operation information transmission) such that gas of an amount corresponding to the approval information is supplied to the gas pump 210 corresponding to the gas pump identification information included in the order information. Furthermore, the local server 220 may transmit the approval information to the corresponding gas pump 210 such that the gas pump 210 outputs a receipt.

Meanwhile, in various exemplary embodiments of the present invention, the affiliated gas station server 400 may be omitted and the payment platform server 300 may be implemented to directly communicate with the local server 220 of the gas station.

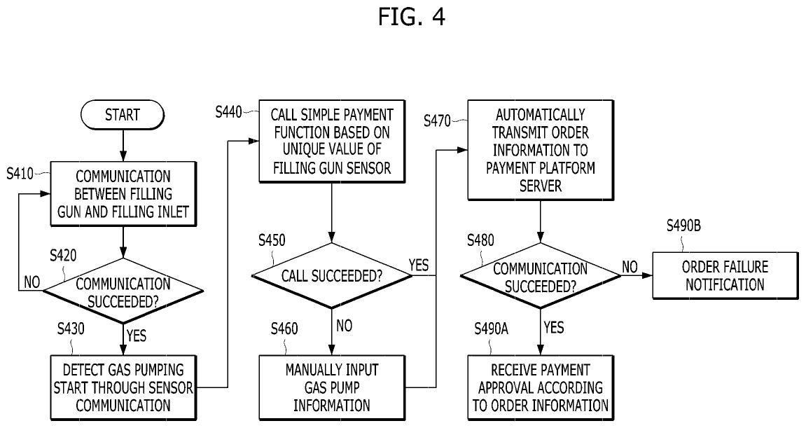

FIG. 4 is a flowchart illustrating an example of a gas pumping process from the viewpoint of a driver according to an exemplary embodiment of the present invention.

Referring to FIG. 4, a driver may open an oil fill cap and insert the filling gun into the filling inlet to perform communication between the filling gun and the filling inlet such that the filling inlet sensor acquires the gas pump identification information from the filling gun sensor (S410).

When communication succeeds (Yes of S420), the AVN system may detect gas pumping start through sensor communication (that is, gas pump identification information acquisition) (S430), and call a simple payment function based on the unique value of the filling gun sensor (that is, the gas pump identification information) (S440). At the instant time, the simple payment function may be an application executed in the AVN system and may be performed in a smartphone or a tablet connected to the AVN system in various exemplary embodiments. In the instant case, the smartphone or the tablet may perform a function after acquiring the gas pump identification information, e.g., a function for interfacing with the payment platform server 300, and return the order information to the AVN system after the driver confirms the order information.

When calling of the simple payment function fails due to communication error or sensor failure (No of S450), a user may manually input gas pump information to the AVN system (S460).

The AVN system may generate order information and payment means information through the called simple payment information and automatically transmit the order information to the payment platform server 300 (S470).

When communication with the payment platform server 300 succeeds (Yes of S480), the AVN system may receive payment approval information according to the order information (S490A), and otherwise, the AVN system may receive order failure notification information (S490B).

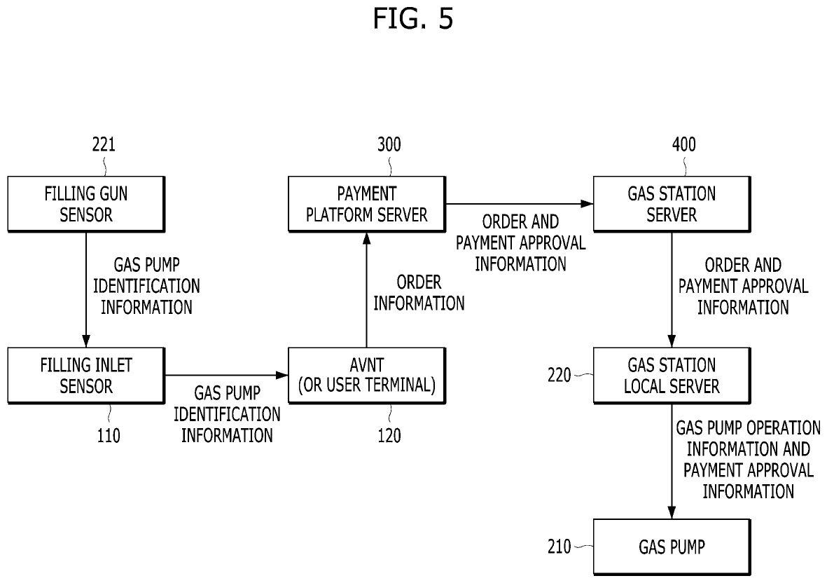

FIG. 5 is a flowchart illustrating a gas pumping process according to an exemplary embodiment of the present invention.

Referring to FIG. 5, as a driver inserts the filling gun into the filling inlet, the filling gun sensor 221 transmits gas pump identification information to the filling inlet sensor 110.

The filling inlet sensor 110 transmits the gas pump identification information to the AVNT 120, and the AVNT 120 generates order information based on the gas pump identification information and transmits the order information to the payment platform server 300. In various exemplary embodiments of the present invention, when the simple payment function is performed in the user terminal instead of the AVNT 120, the gas pump identification information may be transmitted to the user terminal.

The payment platform server 300 may perform payment processing based on the order information and transmit the order information and payment approval information to the affiliated gas station server 400.

The affiliated gas station server 400 determines the gas station based on the gas station identification information related to the order information and transmits the order information and the payment approval information to the local server 220 of the gas station. The local server 220 of the gas station transmits gas pump operation information and the payment approval information to a gas pump 210 corresponding to the gas pump identification information.

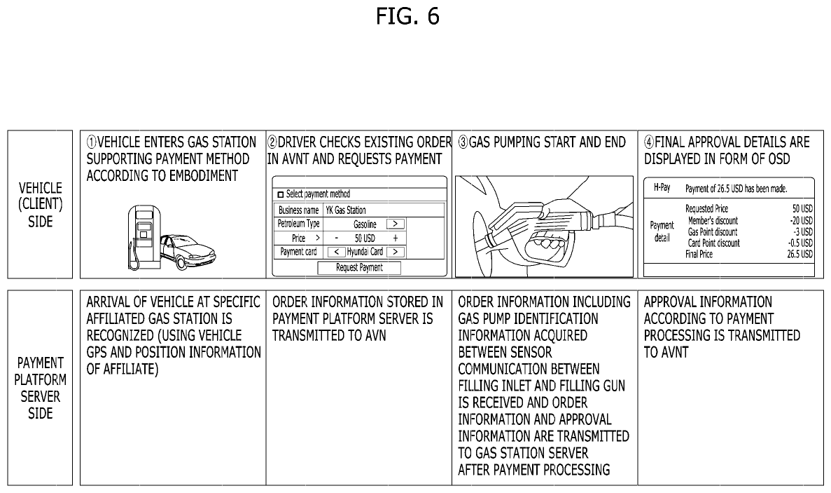

FIG. 6 is a view showing an example of a charging process from the viewpoint of a client and a server according to an exemplary embodiment of the present invention. In FIG. 6, assume that the payment platform server 400 periodically acquires the position information related to the vehicle and determines whether the vehicle enters the gas station, and payment means information is stored in the payment platform server 400.

Referring to FIG. 6, the vehicle may enter a gas station supporting a simple payment method based on gas pump identification information according to an exemplary embodiment (\textcircled{1}). At the instant time, the payment platform server 400 may compare the periodically acquired position information related to the vehicle with position information related to an affiliate and determine whether the vehicle enters a specific gas station.

Upon determining that the vehicle enters the affiliated gas station, the payment platform server 400 may transmit at least payment means information related to the information stored in connection with the vehicle to the vehicle. At the instant time, when previous order information is stored in the payment platform server 400, order information including payment amount information in addition to the payment means information may be transmitted to the vehicle. Therefore, the simple payment function may be displayed on the display of the AVN system of the vehicle and order information according to settings stored in the server 400 may be output (\textcircled{2}).

When a driver makes a request for payment in advance and inserts the filling gun of the gas pump into the filling inlet, the AVNT may acquire the gas pump identification information related to the gas pump through sensor communication between the filling inlet and the filling gun. Therefore, the AVNT may include gas pump identification information in the order information and transmit the order information to the payment platform server 400, starting pumping gas according to payment approval (\textcircled{3}).

The payment approval information may be transmitted from the payment platform server 400 to the AVNT, and the AVNT may output final approval details on the display in a form of OSD according to approval information (\textcircled{4}).

In a general gas station payment system, a customer needs to directly check and input a gas pump number. Although a method of installing a beacon in each gas pump and performing communication using a Bluetooth module within the vehicle is applied, interference or scattered reflection may frequently occur by various environmental variables in the gas station due to short-range communication characteristics. However, when the payment system according to the exemplary embodiments is used, sensor communication may be performed due to contact between the filling inlet and the filling gun when pumping gas, and the vehicle may acquire the gas pump identification information such that the terminal (e.g., the AVNT) within the vehicle may generate order information based on the above information and transmit the order information to the payment platform. Accordingly, the customer may conveniently receive the simple payment service in the gas station without inputting the gas pump identification information. Furthermore, in the present process, since communication between the terminal within the vehicle and the server is performed, the vehicle may naturally satisfy a trigger condition of various personalization services according to entry into the gas station.

Meanwhile, although the gas pump of the gas station for supplying liquid fossil fuels such as gasoline or diesel oil and the filling gun provided therein have been described in the above-described embodiments, the above-described embodiments are applied to an external charger of an electric vehicle charging station for charging electric vehicles and a plug provided therein, recognizing a charger using a similar method. In the instant case, the fuel type information related to payment information may be replaced with a charging method (slow/fast) and pumped gas amount information may be replaced with charge amount information. For example, in the exemplary embodiments of the present invention, a socket, into which the filling inlet and the plug are inserted, may be collectively referred to as an “insertion inlet”, the filling gun and the plug may be collectively referred to as an “insertion part”, and the gas pump and the external charger may be collectively referred to as a “supply unit”.

In brief, the vehicle according to various exemplary embodiments of the present invention includes a charger identification information acquirer for acquiring identification information related to the charger from a charger identification information provider provided in the plug as the plug of the charger is inserted into the socket, and a terminal for generating order information based on the acquired identification information and transmitting the order information to a payment server. The charger identification information acquirer may acquire the identification information from the charger identification information provider using a non-contact recognition method in a state in which the plug is inserted into the socket.

For example, the charger identification information acquirer may approach the charger identification information provider within a predetermined distance in a state in which the plug is inserted into the socket.

For example, the charger identification information acquirer may be disposed near the socket.

For example, the charger identification information acquirer may include a near field communication (NFC) reader, and the charger identification information provider may include an NFC tag.

For example, the non-contact recognition method may include at least one of an infrared (IR) communication method, a visible light communication method, a magnetic secure transmission (MST) method, an acoustic communication method, and a quick response (QR) code method.

For example, the order information may include at least one of charger identification information, payment means information, charging method (slow/fast) information, requested payment amount information or request charge amount information, and the payment means information may include at least one of a credit card number, a membership number, discount means information, installment information, and loyalty card information.

Furthermore, a charger identification system according to various exemplary embodiments of the present invention includes a vehicle including a charger identification information acquirer for acquiring identification information related to the charger from a charger identification information provider provided in the plug as the plug of the charger is inserted into a socket and a terminal for generating order information based on the acquired identification information, and a payment server for receiving the generated order information from the terminal and making payment based on the order information. The charger identification information acquirer may acquire the identification information from the charger identification information provider using a non-contact recognition method in a state in which the plug is inserted into the socket.

For example, the charger identification system may further include a local server for receiving approval information related to the payment and the order information from the payment server and a charging station including the charger. The local server may determine the charger based on the identification information included in the order information and transmit charger operation information corresponding to the order information to the charger.

The gas pump identification system according to at least an exemplary embodiment of the present invention having the above-described configuration can conveniently identify the gas pump through the non-contact type sensors respectively provided in the filling inlet and the filling gun.

In particular, it is possible to identify the gas pump by inserting the filling gun into the filling inlet without being influenced by a surrounding environment and to conveniently make payment for gas.

The effects of the present invention are not limited to the above-described effects and other effects which are not described herein may be derived by those skilled in the art from the above description of the exemplary embodiments of the present invention.

The present invention can also be embodied as computer readable code on a computer readable recording medium. The computer readable recording medium is any data storage device that can store data which can thereafter be read by a computer system. Examples of the computer readable recording medium include read-only memory (ROM), random-access memory (RAM), CD-ROMs, magnetic tapes, floppy disks, and optical data storage devices.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A method of controlling a gas pump identification system, the method comprising:
acquiring, by a gas pump identification information acquirer disposed in a vehicle, identification information related to a gas pump from a gas pump identification information provider provided in a filling gun while the filling gun of the gas pump is inserted into a filling inlet of the vehicle;
transmitting, by a gas pump identification information acquirer, the acquired identification information to a terminal of the vehicle; and
generating, by the terminal, order information based on the identification information and transmitting the order information to a payment server,
wherein the gas pump identification information acquirer is configured for acquiring the identification information from the gas pump identification information provider using a non-contact recognition method in a state in which the filling gun is inserted into the filling inlet.

2. The method according to claim 1, wherein the gas pump identification information acquirer is configured to approach the gas pump identification information provider within a predetermined distance while the filling gun is inserted into the filling inlet.

3. The method according to claim 1, wherein the gas pump identification information acquirer is mounted adjacent to the filling inlet.

4. The method according to claim 1,
wherein the gas pump identification information acquirer is mounted in an oil flow pipe positioned between the filling inlet and a fuel tank, and
wherein the gas pump identification information provider is mounted on a nozzle of the filling gun.

5. The method according to claim 1,
wherein the gas pump identification information acquirer includes a near field communication (NFC) reader, and
wherein the gas pump identification information provider includes an NFC tag.

6. The method according to claim 1,
wherein the non-contact recognition method includes at least one of an infrared (IR) communication method, a visible light communication method, a magnetic secure transmission (MST) method, an acoustic communication method, and a quick response (QR) code method.

7. The method according to claim 1, further including:
making, by the payment server, payment based on the order information; and
transmitting approval information related to the payment and the order information to a local server of a gas station having the gas pump.

8. The method according to claim 7, further including:
determining, by the local server, the gas pump based on the identification information included in the order information; and
transmitting, by the local server, gas pump operation information corresponding to the order information to the gas pump.

9. The method according to claim 1,
wherein the order information includes at least one of gas pump identification information, payment means information, fuel type information, requested payment amount information, and requested fuel amount information, and
wherein the payment means information includes at least one of a credit card number, a membership number, discount means information, installment information, and loyalty card information.

10. A non-statutory computer readable recording medium having recorded thereon a program for executing the method of controlling the gas pump identification system according to claim 1.

11. A vehicle including:
a gas pump identification information acquirer configured to acquire identification information related to a gas pump from a gas pump identification information provider provided in a filling gun while the filling gun of a gas pump is inserted into a filling inlet of the vehicle; and
a terminal configured to generate order information based on the identification information and to transmit the order information to a payment server,
wherein the gas pump identification information acquirer is configured for acquiring the identification information from the gas pump identification information provider using a non-contact recognition method in a state in which the filling gun is inserted into the filling inlet.

12. The vehicle according to claim 11, wherein the gas pump identification information acquirer is configured to approach the gas pump identification information provider within a predetermined distance while the filling gun is inserted into the filling inlet.

13. The vehicle according to claim 11, wherein the gas pump identification information acquirer is mounted adjacent to the filling inlet.

14. The vehicle according to claim 11,
wherein the gas pump identification information acquirer is mounted in an oil flow pipe positioned between the filling inlet and a fuel tank, and
wherein the gas pump identification information provider is mounted on a nozzle of the filling gun.

15. The vehicle according to claim 11,
wherein the gas pump identification information acquirer includes a near field communication (NFC) reader, and
wherein the gas pump identification information provider includes an NFC tag.

16. The vehicle according to claim 11,
wherein the non-contact recognition method includes at least one of an infrared (IR) communication method, a visible light communication method, a magnetic secure transmission (MST) method, an acoustic communication method, and a quick response (QR) code method.

17. The vehicle according to claim 11,
wherein the order information includes at least one of gas pump identification information, payment means information, fuel type information, requested payment amount information, and requested fuel amount information, and
wherein the payment means information includes at least one of a credit card number, a membership number, discount means information, installment information, and loyalty card information.

19. A gas pump identification system comprising:
a vehicle including a gas pump identification information acquirer configured to acquire identification information related to a gas pump from a gas pump identification information provider provided in a filling gun while the filling gun of a gas pump is inserted into a filling inlet of the vehicle and a terminal configured to generate order information based on the acquired identification information; and
a payment server configured to receive the generated order information from the terminal and to make payment based on the order information,
wherein the gas pump identification information acquirer is configured for acquiring the identification information from the gas pump identification information provider using a non-contact recognition method in a state in which the filling gun is inserted into the filling inlet.

19. The gas pump identification system according to claim 18, further including:
a local server configured to receive approval information related to the payment and the order information from the payment server and a gas station having the gas pump,
wherein the local server is configured to determine the gas pump based on the identification information included in the order information and to transmit gas pump operation information corresponding to the order information to the gas pump.

20. A vehicle comprising:
a charger identification information acquirer configured to acquire identification information related to a charger from a charger identification information provider provided in a plug of the charger as the plug of the charger is inserted into a socket; and
a terminal configured to generate order information based on the acquired identification information and to transmit the order information to a payment server,
wherein the charger identification information acquirer is configured for acquiring the identification information from the charger identification information provider using a non-contact recognition method in a state in which the plug is inserted into the socket.
